(19) United States
(12) Patent Application Publication
(10) Pub. No.: US 2026/0239519 A1
(43) Pub. Date: Aug. 13, 2026

(54) STRUCTURE OF PROTECTION DEVICE FOR ELECTROSTATIC DISCHARGE

(71) Applicant: PANSTAR SEMICONDUCTOR CO., LTD., Hsinchu (TW)

(72) Inventor: I-Hua LIN, Hsinchu (TW)

(21) Appl. No.: 19/530,497

(22) Filed: Feb. 5, 2026

(30) Foreign Application Priority Data
Feb. 11, 2025 (TW) 114105082

(51) Int. Cl. H05F 3/00

(52) U.S. Cl. CPC H05F 3/00

(57) ABSTRACT

A structure of protection device for electrostatic discharge (ESD) is disclosed, including a first metal routing layer, a second metal routing layer, and a current redistribution structure. The first metal routing layer is connected to a first device. The second metal routing layer is connected to a second device. The first metal routing layer is spaced apart from the second metal routing layer. The current redistribution structure is disposed between the first metal routing layer and the second metal routing layer. The current redistribution structure includes a current redistribution metal, a contact, and a diffusion region disposed on a substrate. The current redistribution metal is disposed to have a spacing from the first metal routing layer and the second metal routing layer. The contact is connected to the current redistribution metal. The diffusion region is connected to the contact. The diffusion region has a same doping type as the substrate.

### CROSS REFERENCE TO RELATED APPLICATION

This application claims priority to Tiawan Patent Application No. 114105082 filed on February 11, 2025, the contents of which are incorporated herein by reference in its entirety.

### TECHNICAL FIELD

The present invention relates to a structure, and in particular, to a structure of protection device for electrostatic discharge (ESD).

### BACKGROUND

In a semiconductor device, an electrostatic protection device is often provided to prevent a device from being damaged by static electricity. However, when an input/output (IO) device undergoes junction breakdown and a snapback state, a phenomenon of non-uniform conduction of a current easily occurs in a path of a metal pad of the IO device, the IO device, a grounded device, and a metal pad of the grounded device, increasing a probability of device damage. Therefore, improving the phenomenon of non-uniform conduction of a current for the electrostatic protection device is a technical problem to be solved.

### SUMMARY

To solve the foregoing technical problem to be solved, embodiments of the present invention provide a structure of protection device for electrostatic discharge (ESD), including a first metal routing layer, a second metal routing layer, and a current redistribution structure. The first metal routing layer is connected to a first device. The second metal routing layer is connected to a second device. The first metal routing layer is spaced apart from the second metal routing layer. The current redistribution structure is disposed between the first metal routing layer and the second metal routing layer. The current redistribution structure includes a current redistribution metal, a contact, and a diffusion region. The current redistribution metal is disposed to have a spacing from the first metal routing layer and the second metal routing layer. The contact is connected to the current redistribution metal. The diffusion region is connected to the contact.

Compared with the prior art, the current redistribution structure provided in the embodiments of the present invention has a relatively low resistance, and forms a current redistribution path, so that the current can be effectively dispersed when junction breakdown occurs in an input/output (IO) device, to improve the technical problem of non-uniform conduction of a current.

### BRIEF DESCRIPTION OF THE DRAWINGS

To make the foregoing and other purposes, features, advantages, and embodiments of the present invention clearer and easier to understand, the accompanying drawings are described below.

FIG. 1 is a schematic top view of a configuration of a metal routing layer of an electrostatic protection device.

FIG. 2 is a schematic cross-sectional view of a current path of a device to which an electrostatic protection device is connected.

FIG. 3A is a schematic top view of a current redistribution structure applied to an electrostatic protection device according to an embodiment of the present invention.

FIG. 3B is a schematic cross-sectional view of a current redistribution structure applied to an electrostatic protection device according to an embodiment of the present invention.

FIG. 3C is a schematic cross-sectional view of a current redistribution structure applied to an electrostatic protection device according to another embodiment of the present invention.

### DETAILED DESCRIPTION

Various embodiments are to be described in the specification, and a person having ordinary skill in the art can easily understand the spirit and principles of the present invention by referring to the accompanying drawings. Herein, elements or parts illustrated in the figures may be exaggerated or changed for clarity. Therefore, a person having ordinary skill in the art should understand that sizes and relative proportions of devices or parts illustrated in the figures are not actual sizes and relative proportions of the elements or parts. In addition, although some specific embodiments are to be specifically described herein, these embodiments are only illustrative and are not to be considered limited or exhaustive in all aspects. Therefore, various changes and modifications of the present invention should be obvious and easily implemented for a person having ordinary skill in the art without departing from the spirit and principles of the present invention.

It should be understood that although terms "first", "second", "third", and the like may be used herein to describe various elements, components, regions, layers, and/or parts, these elements, components, regions, and/or parts should not be limited by these terms. These terms are only used to distinguish one element, component, region, layer, or part from another element, component, region, layer, or part. Therefore, "first element", "component", "region", "layer", or "part" discussed below may be referred to as a second element, component, region, layer, or part without departing from the teachings herein.

In addition, conventional elements in the embodiments of the present invention are not to be described in detail or are to be omitted, so as to avoid obscuring relevant details. In the following description, for the purpose of explanation rather than limitation, specific details are set forth in the figures and specification to provide a thorough understanding of the embodiments of the present invention. However, it is apparent that the embodiments may be implemented without these specific details.

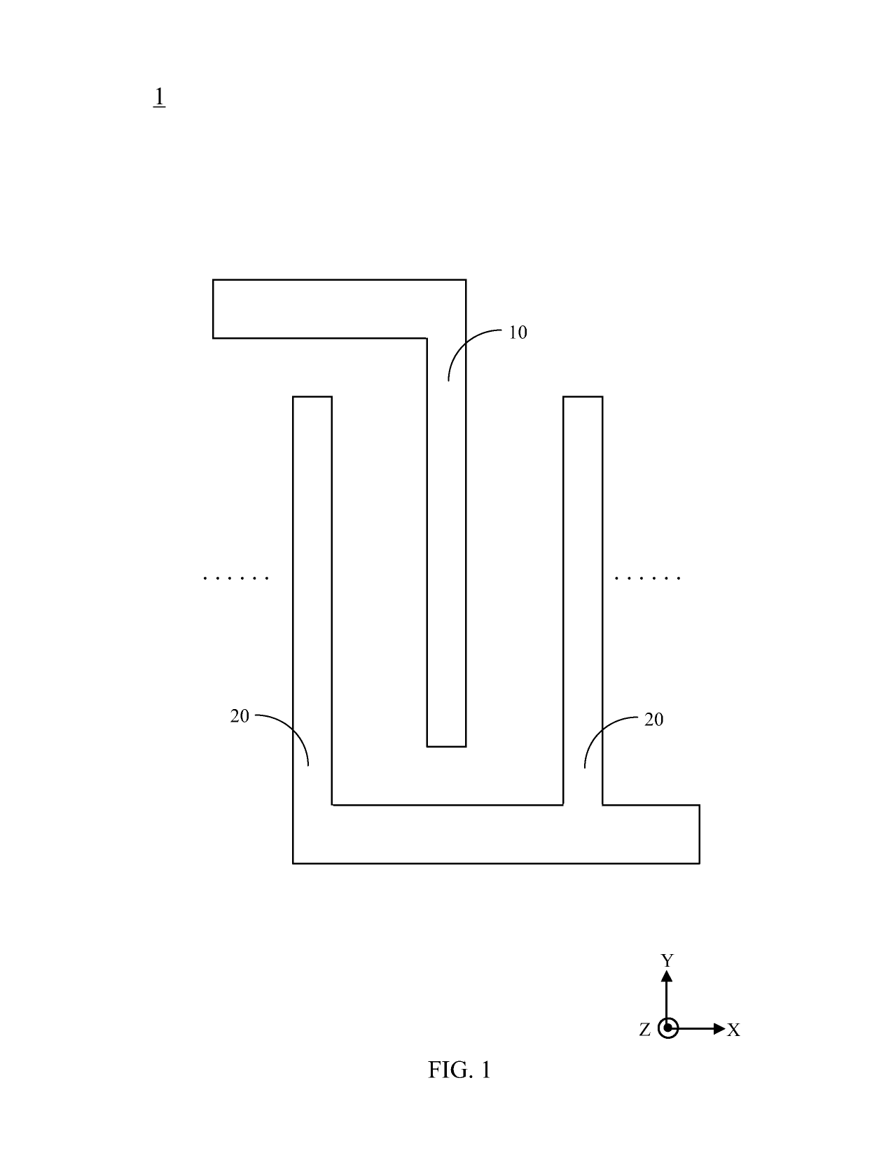

FIG. 1 is a schematic top view of a configuration of a metal routing layer of an electrostatic protection device. In FIG. 1, a metal routing layer of an electrostatic protection device 1 is configured in a finger type as shown in FIG. 1. For example, a first metal routing layer 10 and a second metal routing layer 20 included in the electrostatic protection device 1 are configured as a periodic spacing structure on an X-Y plane in FIG. 1.

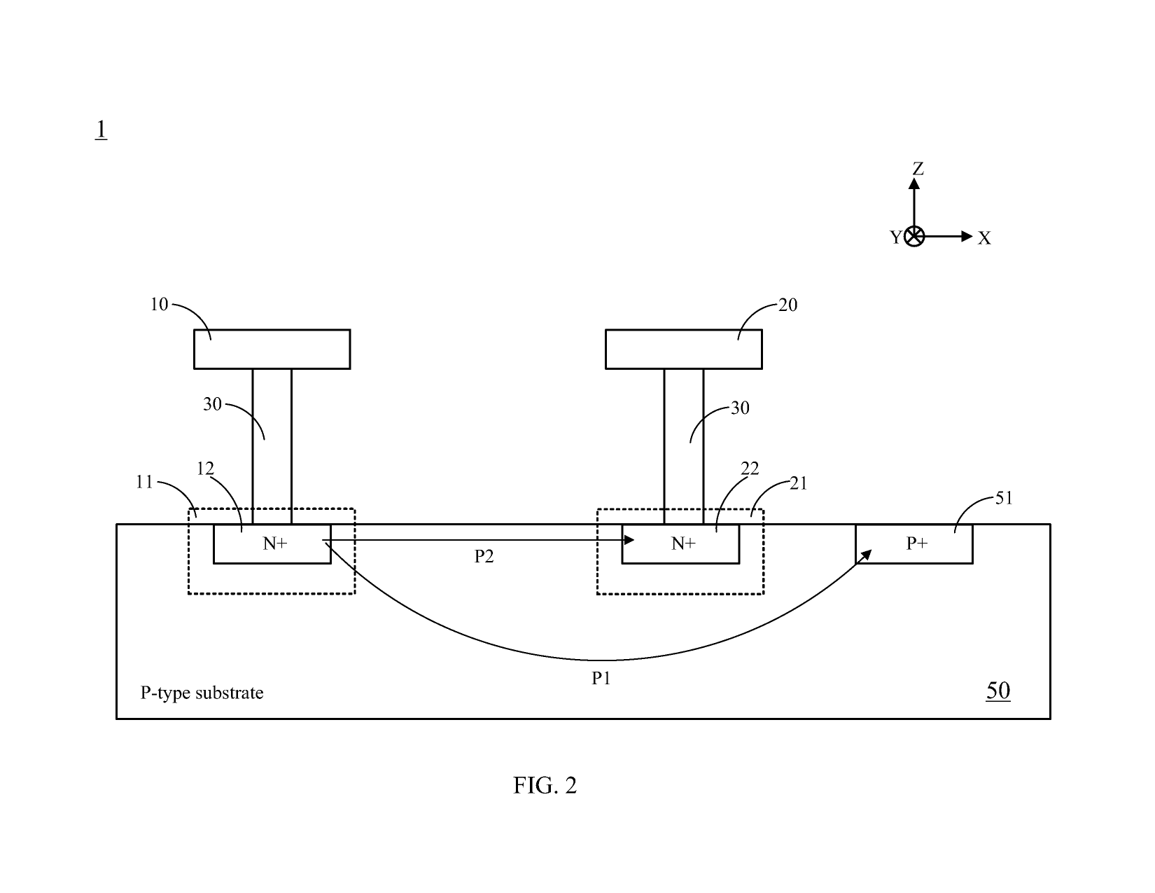

Various features of the electrostatic protection device 1 are described with reference to FIG. 2. FIG. 2 is a schematic cross-sectional view of a current path of a device to which an electrostatic protection device is connected. In FIG. 2, the first metal routing layer 10 of the electrostatic protection device 1 may be connected to different devices through a contact 30, such as, but not limited to, a metal oxide semiconductor field effect transistor (MOSFET), a bipolar junction transistor (BJT), a capacitor, a resistor, or the like.

In FIG. 2, the first metal routing layer 10 is connected to a first device 11 through the contact 30. For example, the first device 11 is an N-type MOSFET disposed on a P-type substrate 50 and operating at a power supply voltage. In addition, the second metal routing layer 20 is connected to a second device 21 through the contact 30. For example, the second device 21 is another N-type MOSFET disposed on the P-type substrate 50 and operating at a grounded voltage. It should be noted that, for the purpose of description, only a high-concentration N-type (N+) doped region 12 of the N-type MOSFET is depicted to represent the first device 11. Similarly, only an N+ doped region 22 of the N-type MOSFET is depicted to represent the second device 21. Further, only a high-concentration P-type (P+) doped region 51 is depicted as a representative in a pick-up region of the P-type substrate 50 in FIG. 2.

In FIG. 2, when junction breakdown occurs in the first device 11 in operation, a current tends to flow from a random point at a junction between the N+ doped region 12 of the first device 11 and the P-type substrate 50 to the pick-up region of the P-type substrate 50. In other words, a path P1 formed by the N+ doped region 12, the P-type substrate 50, and the P+ doped region 51 has a low series resistance. In addition, when the current flows along the path P1, a potential of the P-type substrate 50 is risen.

Further, when the potential of the P-type substrate 50 continues to rise until a difference from a potential of the N+ doped region 12 of the second device 21 exceeds a critical value (for example, 0.7 volts), the N+ doped region 12 of the first device 11, the P-type substrate 50, and the N+ doped region 22 of the second device 21 form a conductive NPN-type bipolar junction transistor. In this case, the electrostatic protection device 1 enters a snapback state. The electrostatic protection device 1 in the snapback state has a lower series resistance in a path P2 formed by the N+ doped region 12, the P-type substrate 50, and the N+ doped region 22. In other words, the current flows in a path formed through a random point at the junction between the N+ doped region 12 and the P-type substrate 50, the P-type substrate 50, and the junction between the P-type substrate 50 and the N+ doped region 22. Therefore, a current flowing from the first metal routing layer 10 to the second metal routing layer 20 through the first device 11 and the second device 21 easily produces a non-uniform conduction, causing the first device 11 and the second device 21 to be more susceptible to damage.

In the foregoing situation, if the electrostatic protection device 1 can cause the current to flow along a direction perpendicular to the path P2 in the P-type substrate 50 (for example, a Y-axis direction in FIG. 2) in a spreading manner when entering the snapback state, and then flow to the second device 21, the first metal routing layer 10, after passing through the first device 11 and the second device 21, may have a relatively uniform current conduction at the second metal routing layer 20. A detailed description is as follows.

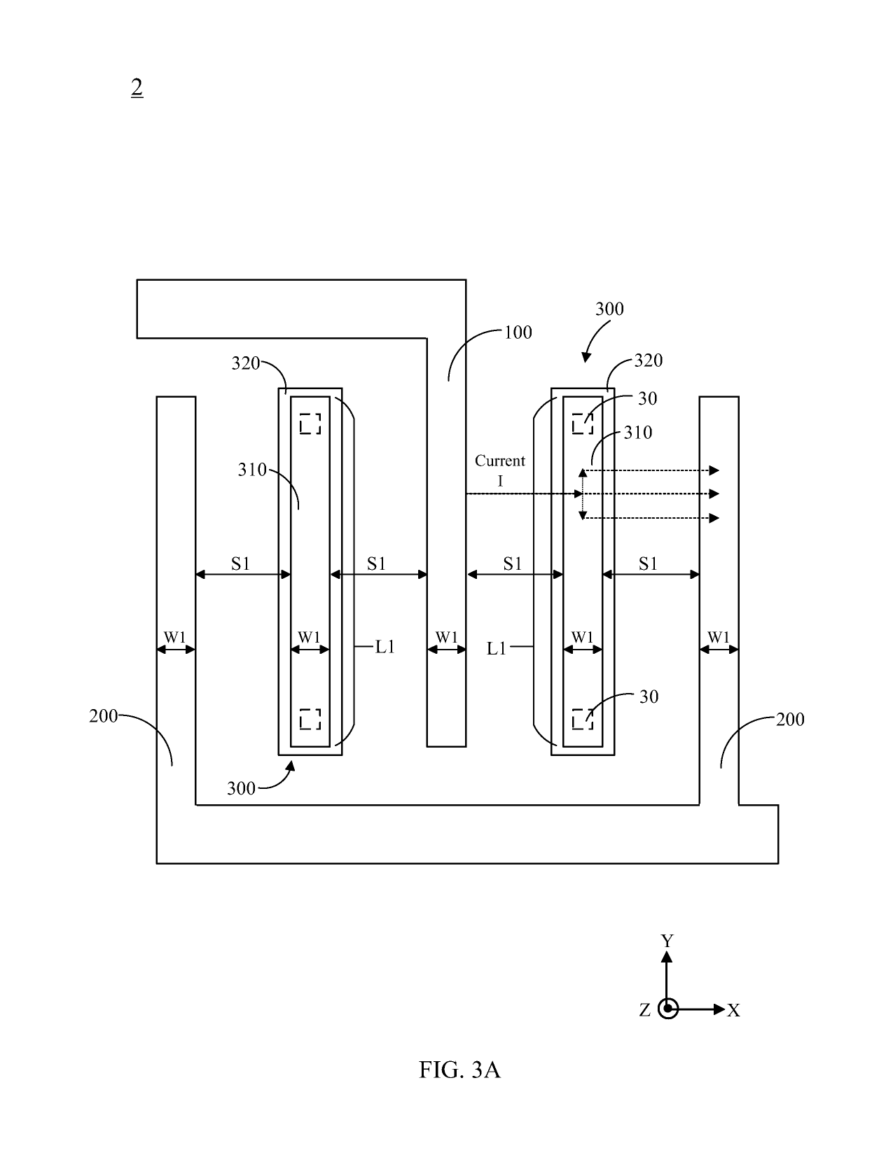

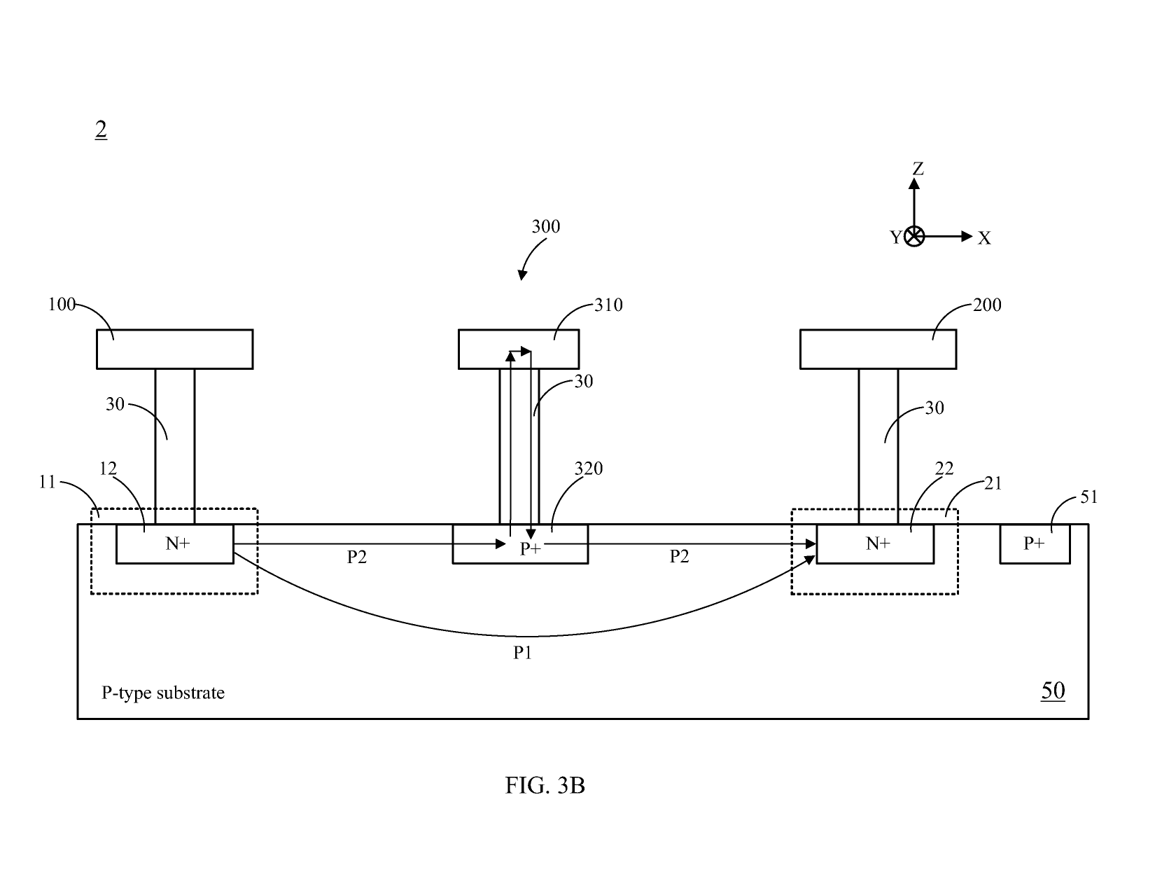

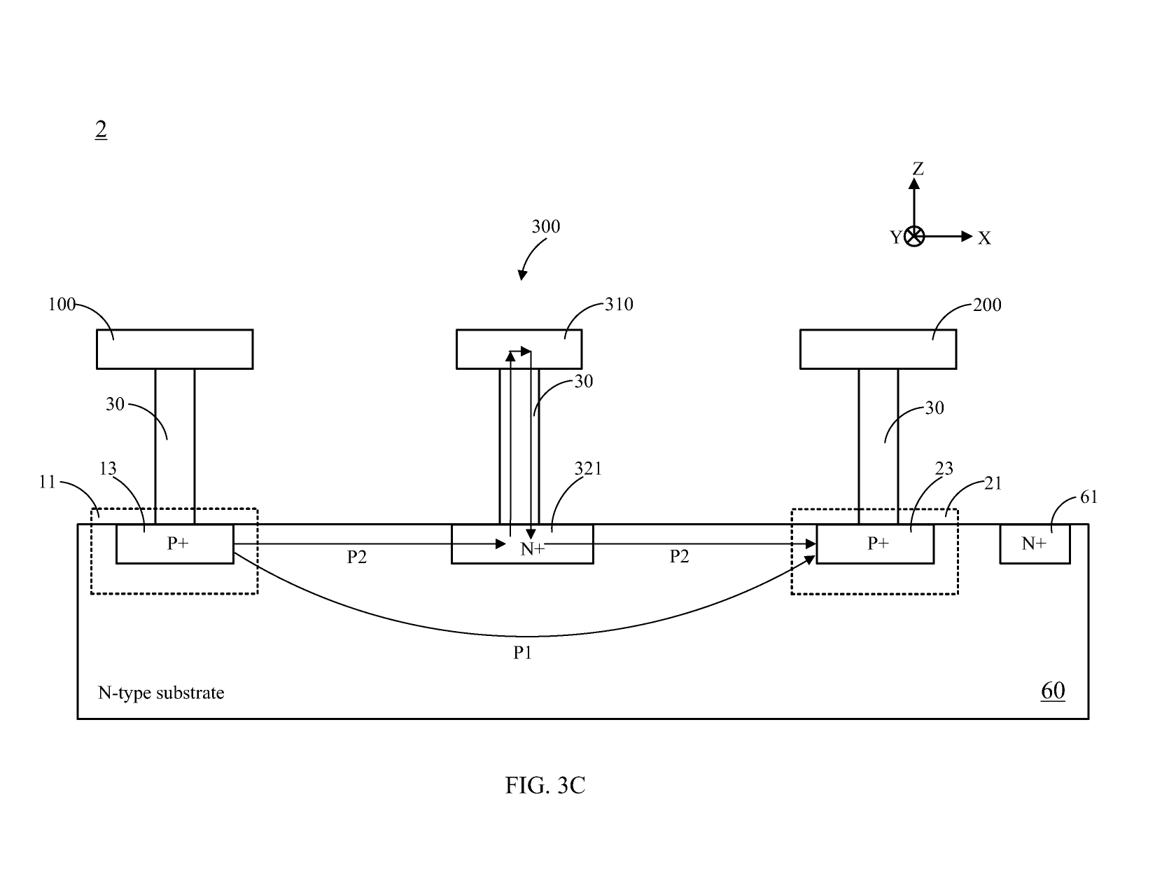

Referring to FIG. 3A and FIG. 3B, FIG. 3A is a schematic top view of a current redistribution structure applied to an electrostatic protection device according to an embodiment of the present invention. FIG. 3B is a schematic cross-sectional view of a current redistribution structure applied to an electrostatic protection device according to an embodiment of the present invention.

As shown in FIG. 3A, an electrostatic protection device 2 is implemented to include a first metal routing layer 100, a second metal routing layer 200, and a current redistribution structure 300. As shown in FIG. 3B, the current redistribution structure 300 includes a current redistribution metal 310, a contact 30, and a diffusion region 320 disposed on a P-type substrate 50. The first metal routing layer 100 is connected to the first device 11 through the contact 30. The second metal routing layer 200 is connected to the second device 21 through the contact 30. The first metal routing layer 100 is spaced apart from the second metal routing layer 200. The first metal routing layer 100, the second metal routing layer 200, and the materials of the current redistribution metal 310 may be implemented to aluminum, copper, or a combination thereof.

In this embodiment, the current redistribution metal 310 is not used as a routing metal. Therefore, the current redistribution metal is not connected to an external power source through the routing metal. In other words, no voltage is applied to the current redistribution metal 310, so that a voltage of the current redistribution metal 310 is in a floating state. In FIG. 3A, the current redistribution metal 310 is disposed to have a spacing S1 from the first metal routing layer 100 and the second metal routing layer 200. The contact 30 of the current redistribution structure 300 is connected to the current redistribution metal 310. In addition, the diffusion region 320 of the current redistribution structure 300 is disposed on the P-type substrate 50. The diffusion region 320 is connected to the contact 30. In FIG. 3B, the diffusion region 320 is implemented to have a same doping type as the P-type substrate 50. For example, both the diffusion region 320 and the P-type substrate 50 are P-type doped regions, and the diffusion region 320 is a P+ diffusion region 320 having a doping concentration much higher than the doping concentration of the P-type substrate 50.

As shown in FIG. 3A and FIG. 3B, the first metal routing layer 100, the second metal routing layer 200, and the current redistribution metal 310 are configured in a finger type. A voltage may be transmitted to the first device 11 through the first metal routing layer 100. The voltage may be transmitted to the second device 21 through the second metal routing layer 200. The current redistribution metal 310 is not connected to any voltage source. As shown in FIG. 3B, the diffusion region 320 is a P+ doped region, and the diffusion region 320 is disposed between the N+ doped region 12 of the first device 11 and the N+ doped region 22 of the second device 21.

In FIG. 3B, when the electrostatic protection device 2 enters a snapback state, a conductive path P1 is formed among the N+ doped region 12 of the first device 11, the P-type substrate 50, and the N+ doped region 22 of the second device 21. However, the N+ doped region 12 of the first device 11, the diffusion region 320, the contact 30, and the current redistribution metal 310 are equivalent to a path P2 with a low series resistance, so that a current is easily redistributed in the current redistribution structure 300 along a Y-axis direction in FIG. 3B and then flows to the N+ doped region 22 of the second device 21 along the path P2.

In this implementation, a current entering the current redistribution structure 300 may first be dispersed in the diffusion region 320 along the Y-axis direction as shown in FIG. 3B, and then flows to the N+ doped region 22 of the second device 21 along the path P2. Alternatively, after entering the diffusion region 320, the current first flows to the current redistribution metal 310 through the contact 30, disperses along the Y-axis direction as shown in FIG. 3A, and then returns to the diffusion region 320 and flows to the N+ doped region 22 of the second device 21 along the path P2. Therefore, the electrostatic protection device 2, through the current redistribution structure 300, causes the current between the first device 11 and the second device 21 to flow more uniformly when the electrostatic protection device 2 enters the snapback state, thereby reducing the probability of damaging the first device 11 and the second device 21.

In this implementation, the first device 11 and the current redistribution structure 300 may be implemented to have a series resistance of a first resistance, and the first device 11, the P-type substrate 50, and the second device 21 may be implemented to have a series resistance of a second resistance, and the first resistance may be equal to or less than the second resistance. Therefore, the electrostatic protection device 2 entering the snapback state redistributes a part of a current in a conductive NPN-type bipolar junction transistor in the path P1 to the path P2.

In FIG. 3A, to form a path P2 having a relatively low series resistance, the diffusion region 320 of the current redistribution structure 300 is configured to have a length in the Y-axis direction greater than a length of the current redistribution metal 310 in the Y-axis direction. For example, a length of the current redistribution metal 310 vertically projected onto a P-type substrate 50 is within a region of a diffusion region 320. Therefore, when the electrostatic protection device 2 enters the snapback state, the current flows from the N+ doped region 12 of the first device 11 to the current redistribution structure 300 with relatively high probability, further redistributing the current in the Y-axis direction as shown in FIG. 3A.

In other words, when the electrostatic protection device 2 enters the snapback state, the current flows from the N+ doped region 12 of the first device 11 bypassing the diffusion region 320 of the current redistribution structure 300 and directly enters the N+ doped region 22 of the second device 21 with relatively low probability. Therefore, the current can be more efficiently dispersed in the current redistribution structure 300 along the Y-axis direction by configuring the length of the diffusion region 320 of the current redistribution structure 300 to be greater than the length of the current redistribution metal 310.

In addition, regarding detailed configurations of the first metal routing layer 100, the second metal routing layer 200, and the current redistribution metal 310, for example, but not limited to, the first metal routing layer 100, the second metal routing layer 200, and the current redistribution metal 310 are configured to have a same width W1. For example, the first metal routing layer 100, the second metal routing layer 200, and the current redistribution metal 310 are configured to have a width for a minimum design rule for routing. Alternatively, for example, but not limited to, the first metal routing layer 100, the second metal routing layer 200, and the current redistribution metal 310 are configured to have a same spacing S1. For example, the first metal routing layer 100, the second metal routing layer 200, and the current redistribution metal 310 are configured to have a spacing for a minimum design rule for routing. Besides, considering a footprint of an entire chip, a footprint of the current redistribution metal 310 should not be excessively large. For example, but not limited to, a length L1 of the current redistribution metal 310 is configured to be less than lengths of the first metal routing layer 100 and the second metal routing layer 200.

Further, the foregoing implementations can also be applied to an N+ diffusion region having a diffusion region with a doping concentration much higher than the doping concentration of the N-type substrate. FIG. 3C is a schematic cross-sectional view of a current redistribution structure applied to an electrostatic protection device according to another embodiment of the present invention. In FIG. 3C, a current redistribution structure 300 of an electrostatic protection device 2 has a diffusion region 321. The diffusion region 321 is implemented as an N+ type doped region. The diffusion region 321 is disposed between a P+ doped region 13 of a first device 11 and a P+ doped region 23 of a second device 21. A substrate is correspondingly configured as an N-type substrate 60 and has an N+ doped region 61 as a pick-up region. The remaining structures are substantially the same as those in the foregoing embodiments. Details are not described again.

The above descriptions are merely some preferred embodiments of the present invention. It should be noted that various changes and modifications can be made to the present invention without departing from the spirit and principles of the present invention. A person having ordinary skill in the art should clearly understand that the present invention is defined by the appended claims, and all possible changes such as substitutions, combinations, modifications, and diversions are within the scope of the present invention defined by the appended claims.

What is claimed is:

1. A structure of protection device for an electrostatic discharge (ESD), comprising:
a first metal routing layer connected to a first device;
a second metal routing layer connected to a second device, wherein the first metal routing layer is spaced apart from the second metal routing layer; and
a current redistribution structure disposed between the first metal routing layer and the second metal routing layer, wherein the current redistribution structure comprises:
a current redistribution metal disposed to have a spacing from the first metal routing layer and the second metal routing layer;
a contact connected to the current redistribution metal; and
a diffusion region connected to the contact.

2. The structure according to claim 1, wherein the diffusion region is disposed on a substrate, and the diffusion region has a same doping type as the substrate.

3. The structure according to claim 1, wherein the first metal routing layer, the second metal routing layer, and the current redistribution metal are configured in a finger type.

4. The structure according to claim 1, wherein the diffusion region is a P-type doped structure, and the diffusion region is disposed between a N-type doped region of the first device and a N-type doped region of a second device.

5. The structure according to claim 1, wherein the diffusion region is a N-type doped structure, and the diffusion region is disposed between a P-type doped region of the first device and a P-type doped region of a second device.

6. The structure according to claim 2, wherein a length of the current redistribution metal vertically projected onto the substrate is within a region of the diffusion region.

7. The structure according to claim 2, wherein when the first device and the second device enter a snapback state, a series resistance of the first device and the current redistribution structure is a first resistance value, and a series resistance of the first device, the substrate, and the second device is a second resistance value, wherein the first resistance value is less than or equal to the second resistance value.

8. The structure according to claim 1, wherein the first metal routing layer, the second metal routing layer, and the current redistribution metal are configured to have a same width.

9. The structure according to claim 1, wherein the current redistribution metal is configured such that a spacing between the current redistribution metal and the first metal routing layer is equal to a spacing between the current redistribution metal and the second metal routing layer.

10. The structure according to claim 8, wherein the first metal routing layer, the second metal routing layer, and the current redistribution metal are made of aluminum, copper, or a combination thereof.

11. The structure according to claim 1, wherein a length of the current redistribution metal is configured to be less than a length of the first metal routing layer, wherein the length of the current redistribution metal is configured to be less than a length of the second metal routing layer.
